(19) United States
(12) Patent Application Publication
(10) Pub. No.: US 2001/0042645 A1
(43) Pub. Date: Nov. 22, 2001

(54) Self- propelled drive wheel

(75) Inventor: Karel van den Berg, Bleskensgraaf (NL)

Correspondence Address: Penrose Lucas Albright, Esq., MASON, MASON & ALBRIGHT, P.O. Box 2246, Arlington, VA, 22202-0246, US

(73) Assignee: LELY RESEARCH HOLDING A.G., a Swiss Limited Liability Company

(21) Appl. No.: 09/883,915

(22) Filed: Jun. 20, 2001

Related U.S. Application Data
(63) Continuation of application No. PCT/NL00/00664, filed on Sep. 19, 2000.

(30) Foreign Application Priority Data
Apr. 26, 2001 (WO) 01/28796 A1
Sep. 20, 1999 (NL) 1013352

(51) Int. Cl. B62D 11/02

(52) U.S. Cl. 180/6.2; 180/219

(57) ABSTRACT

With a vehicle comprising a motor (5; 12; 20, 21; 32, 33) and at least one rotatable element (1, 2; 15; 18, 19; 30, 31) which follows the ground, for the purpose of propelling the vehicle, the motor (5; 12; 20, 21; 32, 33) is adapted for influencing the momentary position of the center of gravity of the vehicle relative to the ground in such a manner that the rotatable element (1, 2; 15; 18, 19; 30, 31) performs a rotation under the influence of gravitational force. The vehicle is compact and has a simple driving mechanism.

The invention relates to a vehicle according to the preamble of claim 1. Vehicles are generally known in many different designs.

The invention aims at providing a compact vehicle with a simple driving mechanism. According to the invention this is achieved by the measures mentioned in the characterizing part of claim 1.

The invention will now be explained in further detail with reference to the accompanying drawings.

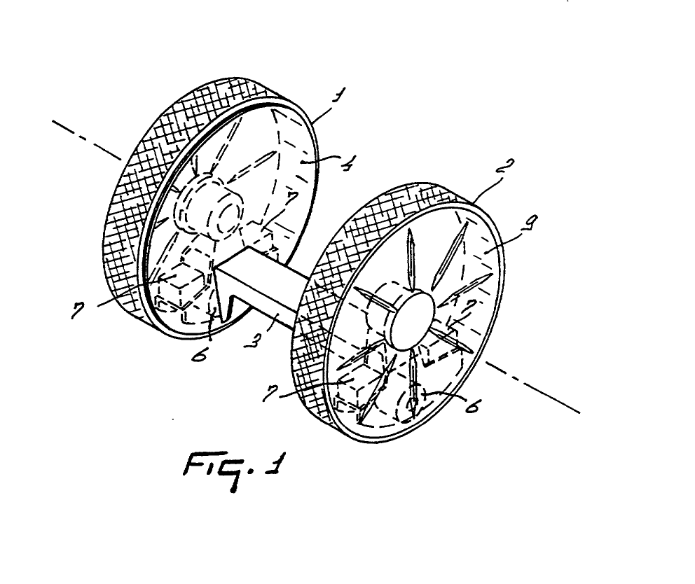

FIG. 1 is a schematic perspective view of an embodiment of a vehicle according to the invention;

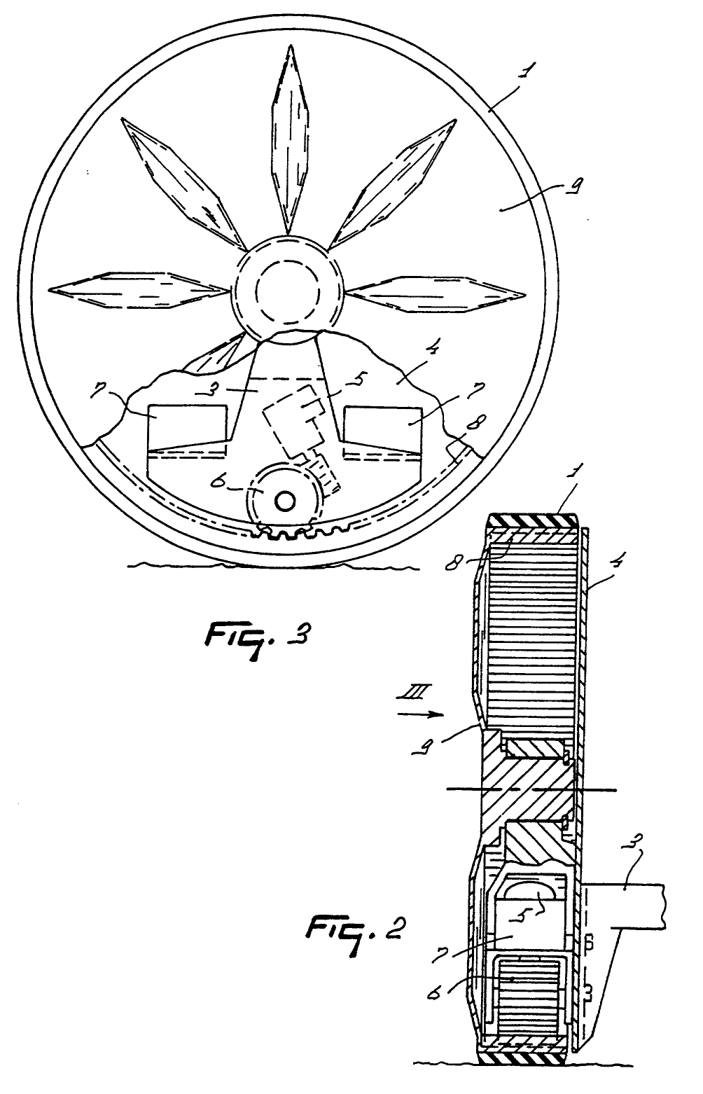

FIG. 2 is a schematic cross-section of a part of the vehicle depicted in FIG. 1;

FIG. 3 is a schematic side view of the vehicle according to the arrow in FIG. 2;

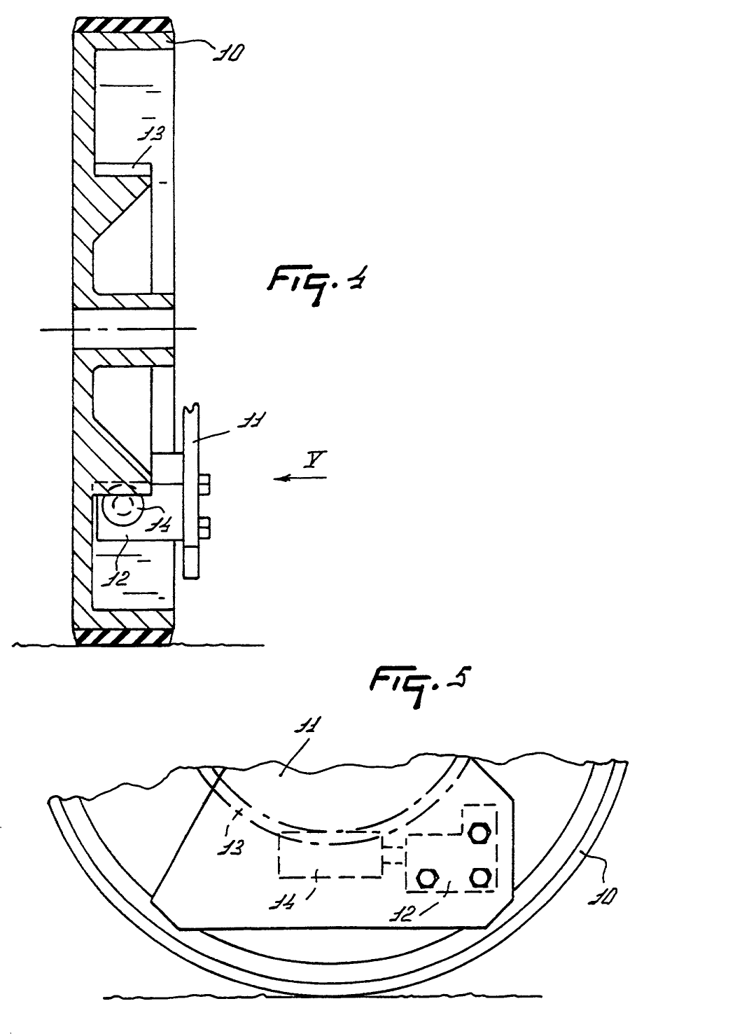

FIG. 4 is a schematic cross-section of a part of a further embodiment of the vehicle according to the invention;

FIG. 5 is a schematic side view of the vehicle according to the arrow in FIG. 4;

FIG. 6 is a schematic perspective view of a still further embodiment of a vehicle according to the invention;

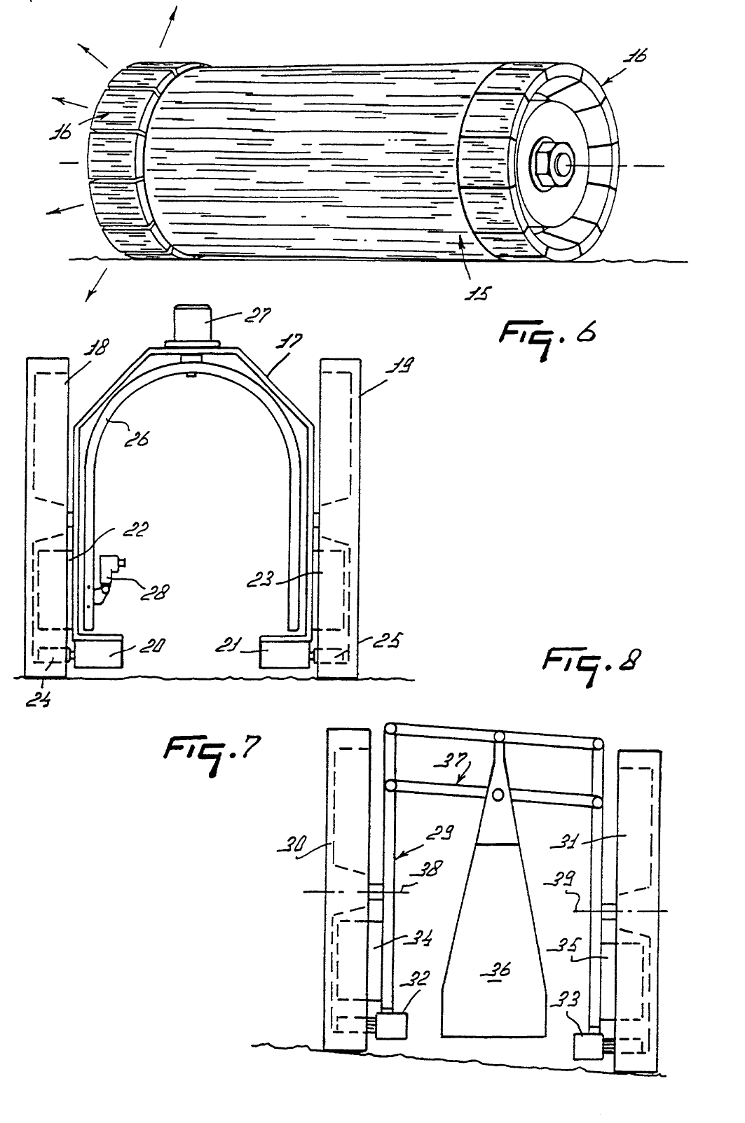

FIG. 7 is a schematic front view of again another embodiment of a vehicle according to the invention, and

FIG. 8 is a schematic front view of another further embodiment of a vehicle according to the invention.

FIGS. 1, 2 and 3 show schematically a perspective view, a cross-section and a side view, respectively, of a first embodiment of a vehicle according to the invention. The vehicle comprises two wheels 1, 2 which are interconnected by means of a frame 3. The middle piece of the frame 3 is connected on both sides to a cover disc 4 (see FIG. 2), which disc 4 is disposed along the inner side of the associated wheel 1, 2 but is not connected to said wheel 1, 2. Each disc 4 is connected itself to a drive unit disposed in the associated wheel 1, 2, which drive unit comprises a motor 5, a drive wheel 6 and accumulators 7 (see FIGS. 2 and 3). Each drive unit may further be made heavier, if desired, by providing it with an extra weight. Each of the motors 5 is suitable for driving, e.g. with the aid of a worm wheel construction, the associated drive wheel 6 which is provided with teeth that co-operate with a toothing 8 on the inner side of the associated wheel 1, 2.

The drive unit which is connected to the frame 3 is freely rotatably suspended, via bearings, from the axis of the associated wheel 1, 2. Said suspension from the physical axis of rotation of the wheel 1, 2 provides a solid construction. The drive wheel 6 driven by the motor 5 ensures that the drive unit loses its position of equilibrium, so that the centre of gravity of the vehicle is displaced and the wheels 1, 2 are put into rotation by the effect of gravitational force. The vehicle will tend to lower its centre of gravity. However, the motor 5 continuously raises the centre of gravity of the vehicle, so that the wheels 1, 2 continue to rotate and the vehicle moves forward in a substantially straight line.

The motors 5 are capable of co-operating for driving the two wheels 1, 2. When the sense of rotation of one of the motors 5 is reversed, the wheels 1, 2 will rotate in opposite direction and the vehicle will rotate about a central, vertical axis. Thus, it is possible to influence the direction of travel of the vehicle. It is also possible to provide the vehicle with a control system which is adapted for making the motor 5 drive selectively neither of the two wheels 1, 2, one of the two wheels 1, 2 or both wheels 1, 2.

The wheels 1, 2 may be made of synthetic material and/or metal and have a diameter which depends on the function and the area of application of the vehicle. On the outer side the wheels 1, 2 may be provided with an outer disc 9 with spokes and/or apertures. It is also possible to use, instead of wheels, one or more rollers and/or one or more blade or paddle wheels.

In a further, non-shown embodiment, the vehicle comprises only one motor 5 which may be fitted in one of the wheels 1, 2 or centrally to the frame 3. The single motor 5 is then capable of driving one of the two wheels 1, 2 or both wheels 1, 2. By adjusting the driving ratio between the two wheels 1, 2 it is possible to steer the vehicle.

In a still further, non-shown embodiment the frame 3 is not connected to the drive units. In this situation the cover discs 4 along with the middle piece of the frame 3 are suspended from the axes of the wheels 1, 2 via bearings, so as to be freely rotatable and loose from the drive units. An advantage of this embodiment is that the completely independent drive units are capable of steering the vehicle more directly. However, it is more difficult to keep the frame 3 stable in a fixed position relative to the ground when the vehicle is travelling.

The vehicle has an excellent manoeuvrability and can be steered accurately. The vehicle is also capable of easily surmounting small obstructions without harmful consequences. The vehicle can be remotely controlled, e.g. by means of a (non-shown) computer which is in connection with the vehicle via a transmitter and receiver unit.

As described in the foregoing, the displacement of the centre of gravity of the vehicle by means of the motor(s) 5 may take place by making a driving weight (e.g. constituted by the motor 5 with its energy supply) rotate about an axis of rotation of a wheel 1, 2, but may also take place by displacing the driving weight in another manner, e.g. with the aid of a (non-shown) element which is capable of sliding out (e.g. a telescopic element) driven by the motor(s) 5.

FIGS. 4 and 5 show schematically a cross-section and a side view of a further embodiment of the vehicle according to the invention. For the sake of simplicity only one wheel 10 of the couple of wheels is depicted. The frame 11 connecting the two wheels is provided with a motor 12 which drives a worm element 13 that co-operates itself with a worm wheel 14 about the axis of the wheel 10. Non-shown accumulators and further weights if any constitute the driving weight which sets the wheel 10 in motion when the driving weight is rotated by the worm wheel construction 13, 14 and the motor 12 about the axis of the wheel 10. Other constructions with gear wheels and/or gear rings are possible as well. The gear wheel construction and/or the worm wheel construction are/is preferably disposed in a closed casing. Thus, the drive is prevented from being contaminated.

FIG. 6 is a schematic perspective view of a still further embodiment of a vehicle according to the invention. Now a roller or cylinder 15, in which the motor and the driving weight are disposed, is used as a rotatable element. The drive works on the same principle as described in the foregoing: the driving weight is displaced by the motor in such a way that the centre of gravity of the vehicle is raised. The roller 15 is provided with a steering mechanism 16 for influencing its direction of travel. Said steering mechanism 16 comprises means for adjusting the momentary distance from the axis of rotation of a part of the roller 15 to the ground.

In the embodiment shown the means mentioned are designed as elements with a variable volume (e.g. an inflatable ring). Other, non-shown options are: an element which is capable of being folded in or out, or an element which is capable of sliding in and out (e.g. a telescopic element). The steering mechanism may also comprise means for adjusting the momentary coefficient of friction of at least a part of the roller 15. Further the vehicle may also comprise two wheels or rollers, which are interconnected by means of a fixed axis. The vehicle may be used e.g. as a pressure roller.

FIG. 7 is a schematic front view of again another embodiment of a vehicle according to the invention. In this situation the vehicle is provided with a frame 17 which is suitable for fastening devices thereto. The wheels 18, 19 are again interconnected via the frame 17. At its lower side the frame 17 is provided with motors 20, 21 and accumulators 22, 23, which constitute the driving weights. The motors 20, 21 drive gear wheels 24, 25 which co-operate with gear rings on the inner side of the wheels 18, 19.

The frame 17 is further provided with a rail 26 which is rotatably fastened (with the aid of a motor 27) to said frame 17 and along which a device, such as e.g. a camera 28, is capable of moving. The camera 28 may be designed so as to be slidable along the rail 26. Thus, the vehicle can be used for observing objects that are not easily accessible.

FIG. 8 is a schematic front view of another further embodiment of a vehicle according to the invention. In this case the vehicle is again provided with a frame 29 which is suitable for fastening devices thereto. The wheels 30, 31 are interconnected via the frame 29. At its lower side the frame 29 is provided with motors 32, 33 with non-shown energy supplies. The motors 32, 33 again drive gear wheels cooperating with gear rings on the inner side of the wheels 30, 31. The frame 29 is further provided with two storage spaces 34, 35 in which a load can be transported. Centrally, a still larger load 36 can be fastened.

The frame 29 comprises a parallelogram construction 37 with the aid of which the axes of rotation 38, 39 of the wheels 30, 31 are displaceable substantially in vertical direction relative to each other. In this way the vehicle is suitable for being used on sloping grounds. Thereby the parts of the frame 29 provided with the storage spaces 34, 35 and the load 36 remain orientated substantially vertically.

1. A vehicle comprising a motor (5; 12; 20, 21; 32, 33) and at least one rotatable element (1, 2; 15; 18, 19; 30, 31) which is in contact with the ground during travelling of the vehicle, characterized in that, for the purpose of propelling the vehicle, the motor (5; 12; 20, 21; 32, 33) is adapted for influencing the momentary position of the centre of gravity of the vehicle relative to the ground in such a manner that the rotatable element (1, 2; 15; 18, 19; 30, 31) performs a rotation under the influence of gravitational force.

2. A vehicle as claimed in claim 1, characterized in that the motor (5; 12; 20, 21; 32, 33) influences the position of the centre of gravity by displacing a driving weight (5, 7; 12; 20-25; 32-36).

3. A vehicle as claimed in claim 2, characterized in that the motor (5; 12; 20, 21; 32, 33) is adapted for driving an element which is capable of sliding out (e.g. a telescopic element) that is connected to the driving weight (5, 7; 12; 20-25; 32-36).

4. A vehicle as claimed in claim 2, characterized in that the motor (5; 12; 20, 21; 32, 33) influences the position of the centre of gravity by rotating the driving weight (5, 7; 12; 20-25; 32-36) about an axis of rotation of the rotatable element (1, 2; 15; 18, 19; 30, 31).

5. A vehicle as claimed in claim 4, characterized in that the axis of rotation of the rotatable element (1, 2; 15; 18, 19; 30, 31) is a physical axis from which the driving weight (5, 7; 12; 20-25; 32-36) is suspended.

6. A vehicle as claimed in any one of claims 1 to 5, characterized in that during travelling the contact surface of the vehicle with the ground is substantially in one line which is situated in a plane extending perpendicular to the ground and through the axis of rotation of the rotatable element (1, 2; 15; 18, 19; 30, 31).

7. A vehicle as claimed in any one of claims 2 to 6, characterized in that the rotatable element (1, 2; 15; 18, 19; 30, 31) is constituted by a roller (15) in which the motor (5; 12; 20, 21; 32, 33) and the driving weight (5, 7; 12; 20-25; 32-36) are disposed.

8. A vehicle as claimed in any one of claims 1 to 7, characterized in that the vehicle is provided with a steering mechanism (16) for influencing its direction of travel.

9. A vehicle as claimed in claim 8, characterized in that, for the purpose of influencing the direction of travel of the vehicle, at least one rotatable element (1, 2; 15; 18, 19; 30, 31) is provided with means (16) for adjusting the momentary distance from the axis of rotation of at least a part of the relevant rotatable element (1, 2; 15; 18, 19; 30, 31) to the ground.

10. A vehicle as claimed in any one of claims 1 to 9, characterized in that the vehicle is provided with two drivable rotatable elements (1, 2; 15; 18, 19; 30, 31) and has two substantially parallel, once passed through contact tracks with the ground.

11. A vehicle as claimed in claim 10, characterized in that the vehicle is provided with a control system which is adapted for making the motor (5; 12; 20, 21; 32, 33) drive selectively neither of the two rotatable elements (1, 2; 15; 18, 19; 30, 31), one of the two rotatable elements (1, 2; 15; 18, 19; 30, 31) or both rotatable elements (1, 2; 15; 18, 19; 30, 31).

12. A vehicle as claimed in claim 10 or 11, characterized in that for each of the rotatable elements (1, 2; 15; 18, 19; 30, 31) there is provided a motor (5; 12; 20, 21; 32, 33).

13. A vehicle as claimed in any one of claims 10 to 12, characterized in that each rotatable element (1, 2; 15; 18, 19; 30, 31) is provided with a driving weight (5, 7; 12; 20-25; 32-36).

14. A vehicle as claimed in claim 13, characterized in that the driving weight (5, 7; 12; 20-25; 32-36) comprises a motor (5; 12; 20, 21; 32, 33) with an energy source, such as an accumulator (7; 22, 23) and/or a solar cell and/or a fuel can.

15. A vehicle as claimed in claim 13 or 14, characterized in that the driving weight (5, 7; 12; 20-25; 32-36) is substantially disposed in the rotatable element (1, 2; 15; 18, 19; 30, 31).

16. A vehicle as claimed in any one of claims 12 to 15, characterized in that each of the two motors (5; 12; 20, 21; 32, 33) is substantially disposed in one of the rotatable elements (1, 2; 15; 18, 19; 30, 31).

17. A vehicle as claimed in any one of claims 10 to 16, characterized in that the axes of rotation of the rotatable elements (1, 2; 15; 18, 19; 30, 31) are substantially in alignment.

18. A vehicle as claimed in any one of claims 1 to 17, characterized in that the motor (5; 12; 20, 21; 32, 33) and/or the driving weight (5, 7; 12; 20-25; 32-36) are/is connected to a gear wheel (6; 24, 25) which is capable of being driven by the motor (5; 12; 20, 21; 32, 33) and which is suitable for co-operating with a gear ring (8) that is connected to a rotatable element (1, 2; 15; 18, 19; 30, 31).

19. A vehicle as claimed in any one of claims 1 to 17, characterized in that the motor (5; 12; 20, 21; 32, 33) and/or the driving weight (5, 7; 12; 20-25; 32-36) are/is connected to a gear ring (8) which is capable of being driven by the motor (5; 12; 20, 21; 32, 33) and which is suitable for co-operating with a gear wheel (6; 24, 25) that is connected to a rotatable element (1, 2; 15; 18, 19; 30, 31).

20. A vehicle as claimed in claim 18 or 19, characterized in that the gear wheel (6; 24, 25) and the gear ring (8) are disposed in a substantially closed casing.

21. A vehicle as claimed in any one of claims 1 to 17, characterized in that the motor (5; 12; 20, 21; 32, 33) and/or the driving weight (5, 7; 12; 20-25; 32-36) are/is connected to a worm element (13) which is capable of being driven by the motor (5; 12; 20, 21; 32, 33) and which is suitable for co-operating with a worm wheel (14) that is connected to a rotatable element (1, 2; 15; 18, 19; 30, 31).

22. A vehicle as claimed in any one of claims 1 to 17, characterized in that the motor (5; 12; 20, 21; 32, 33) and/or the driving weight (5, 7; 12; 20-25; 32-36) are/is connected to a worm wheel (14) which is capable of being driven by the motor (5; 12; 20, 21; 32, 33) and which is suitable for co-operating with a worm element (13) that is connected to a rotatable element (1, 2; 15; 18, 19; 30, 31).

23. A vehicle as claimed in claim 21 or 22, characterized in that the worm element (13) and the worm wheel (14) are disposed in a substantially closed casing.

24. A vehicle as claimed in any one of claims 1 to 23, characterized in that the vehicle is provided with a frame (3; 11; 17; 29) which is suitable for fastening devices (26-28; 34-36) thereto.

25. A vehicle as claimed in claim 24, characterized in that the frame (3; 11; 17; 29) comprises a connecting element between the rotatable elements (1, 2; 15; 18, 19; 30, 31).

26. A vehicle as claimed in claim 25, characterized in that the frame (3; 11; 17; 29) is connected to the driving weight (5, 7; 12; 20-25; 32-36).

27. A vehicle as claimed in claim 25, characterized in that the frame (3; 11; 17; 29) is bearing-supported so as to be freely rotatable about the axis of rotation of the rotatable element (1, 2; 15; 18, 19; 30, 31) and loose from the driving weight (5, 7; 12; 20-25; 32-36).

28. A vehicle as claimed in any one of claims 25 to 27, characterized in that the frame (3; 11; 17; 29) comprises a parallelogram construction (37) with the aid of which the axes of rotation (38, 39) of the rotatable elements (1, 2; 15; 18, 19; 30, 31) are displaceable substantially in vertical direction relative to each other.
